(19) United States
(12) Patent Application Publication
(10) Pub. No.: US 2009/0037918 A1
(43) Pub. Date: Feb. 5, 2009

(54) Thread sequencing for multi-threaded processor with instruction cache

(75) Inventors: Andrew Brown, Berkeley, CA (US); Brian Emberling, Palo Alto, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc., Sunnyvale, CA (US)

(21) Appl. No.: 11/882,305

(22) Filed: Jul. 31, 2007

(51) Int. Cl. G06F 9/46

(52) U.S. Cl. 718/103

(57) ABSTRACT

Execution of the first thread of a new program is prioritized ahead of older threads for a previously running program. The new program is invoked during the execution of a thread of the previous program. The first thread of the program is prioritized ahead of the remaining threads of the previous program. In an embodiment of the invention, additional threads of the new program are also prioritized ahead of the older threads. A thread's context may include a table of constant values that can be referenced by each program and are shared by multiple threads. Changing the values in a constant table for a new thread is time intensive. To avoid changes to the constant table (and thereby save time), a higher priority status is conferred to the first thread that follows a change to the constant table.

### BACKGROUND OF THE INVENTION

1. Field of the Invention

The invention described herein relates to execution of programs in a processor, and more particularly relates to the sequence of execution of program threads.

2. Background Art

It is common for streaming processors to execute a program by executing individual threads of the program. Conventionally, threads must complete in the order they are created. Prioritizing the execution of instructions older threads ahead of newer threads helps ensure that threads complete in the order they were started, particularly if the thread execute the same instructions. If threads can be completed in the order they are created, then fewer threads are in existence at any given time, consuming fewer overall resources. The threads do not necessarily need to complete in order, and often will not, but there are advantages to having them complete in order. Further, it is common practice to load one or more instructions into an instruction cache from memory, prior to the execution of the instruction(s). This avoids the time-intensive process of having to fetch an instruction from memory when the instruction is needed.

Still, in spite of the caching process, some latency remains, given the requirement of having to load one or more instructions into the instruction cache. The latency from the caching process can be so significant that some multi-threaded processors may switch to a different thread while an instruction of the original thread is being cached. Therefore, when processor resources become free, the instructions that need to use these resources have not yet been loaded into the instruction cache. The processor resources will go unused by these instructions until the high latency fetch has been completed. A similar situation exists when a local data cache is used to store constant values referenced by instructions. Here, if an instruction needs a new set of constants (different from the constants currently cached) instruction execution may stall until a new set of constants have been loaded. This problem is particularly important in computer graphics processing. Any data that is accessed through a cache and needed by a shader program, for example, will potentially create this problem.

One commonly implemented method to avoid leaving processor resources unused during an instruction or data fetch is to pre-fetch instructions or data into a cache prior to execution. Such a mechanism generally requires significant additional hardware complexity, however.

There is a need, therefore, for a method and system that allows for the streamlining of the execution of multiple threads. A desired solution would have to avoid the pitfalls of a pre-fetch scheme, while otherwise addressing the above described latency problems in the caching of instructions and data.

### BRIEF DESCRIPTION OF THE DRAWINGS/FIGURES

FIG. 1 illustrates the execution of a first program during which a second program is invoked, such that the priority of the first thread of the second program is elevated above the priorities of the remaining threads of the first program, according to an embodiment of the invention.

FIG. 2 is a flowchart illustrating the process of prioritizing the execution of a first thread of a second program ahead of older threads of a first program, according to an embodiment of the invention.

FIG. 3 is a block diagram illustrating the elevation of the priority of the first thread that follows the introduction of a new constant table, according to an embodiment of the invention.

FIG. 4 is a flowchart illustrating the process of prioritizing execution of the thread ahead of threads that use a different constant table, according to an embodiment of the invention.

FIG. 5 is a block diagram illustrating the computing context of an embodiment of the invention.

### DETAILED DESCRIPTION OF THE INVENTION

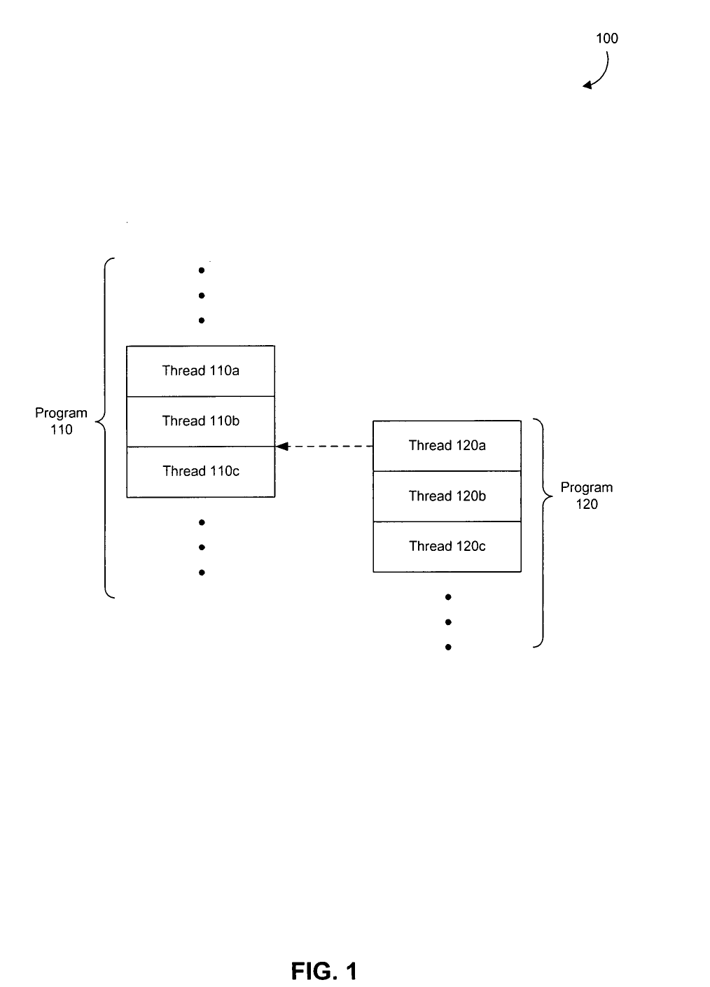

In an embodiment of the invention, the execution of the first thread of a new program is prioritized ahead of older threads for a previously running program. This is illustrated in FIG. 1 as process 100. Two programs are shown, program 110 and program 120. Program 110 includes a number of threads including thread 110a, thread 110b, and thread 110c. In this example, program 120 is invoked during the execution of thread 110b. Because program 120 represents a new program, the first thread of program 120, thread 120a, is prioritized ahead of the remaining threads of program 110. In an embodiment of the invention, additional threads of program 120 are also prioritized ahead of the older threads of program 110. These newly prioritized threads of program 120 can include, for example, threads 120b and 120c. In an alternative embodiment, only thread 120a is prioritized and, subsequent to execution of thread 120a, execution returns to thread 110c. After the newly prioritized thread(s) is (are) executed, the remaining threads of program 110 can be executed, assuming that they have the necessary priority. While prioritizing work for newer threads creates some latency (since additional latency for older threads is caused by scheduling instructions for newer threads ahead of instructions for older threads) this negative effect is offset by the positive effect created by the fact that newer threads will be ready to use processor resources once those resources become available.

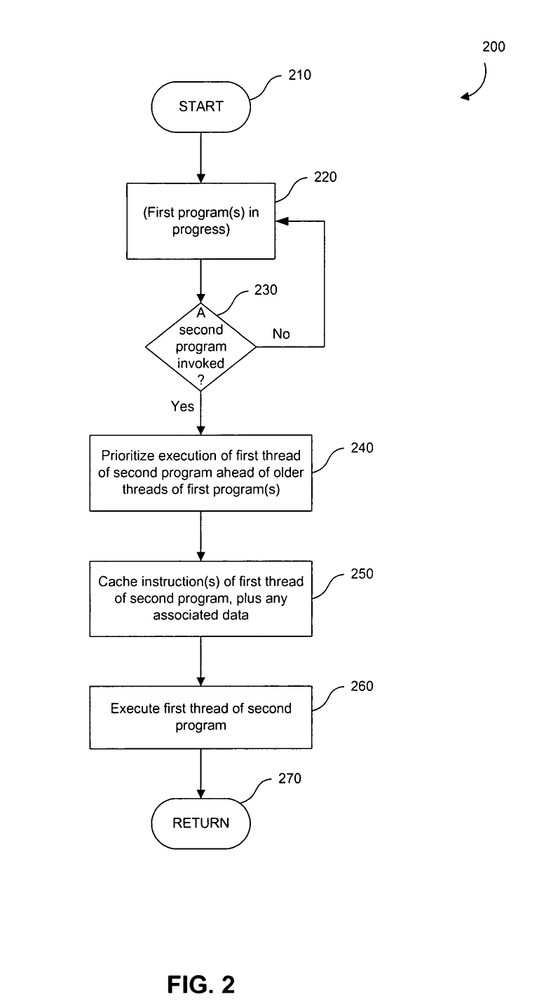

The process of this embodiment is illustrated in greater detail in FIG. 2. The process 200 begins with step 210. In step 220, a first program is currently in progress. Note that other programs may also be in progress at the same time. In step 230, when a second program has been newly invoked, the process continues at step 240. Here, the execution of the first thread of the second program is prioritized ahead of older threads of the currently running first program. In step 250, one or more instructions of the first thread of the second program are placed in an instruction cache. In an embodiment of the program, any data that is associated with the instructions placed in the instruction cache can also be loaded into a cache. In step 260, the first thread of the second program begins execution. The process concludes at step 270.

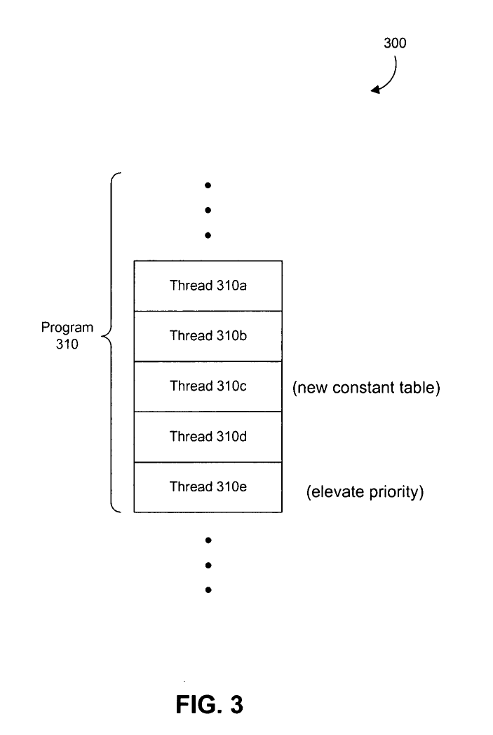

Another embodiment of the invention is illustrated in FIG. 3 as process 300. A thread's context may include a table of constant values that can be referenced by each program and are shared by multiple threads. This can be the case, for example, in computer graphics processing. The paths of instruction execution of threads that use the same shader program, for example, can vary dynamically both as a function of the input data to the thread and also the values in this table of constants. Changing the values in a constant table for a new thread is time intensive. To avoid changes to the constant table (and thereby save time), a higher priority status is conferred to the first thread needing the new constant table that follows a change to the constant table. This is illustrated in FIG. 3. Here a program 310 is executing, where the program includes threads 310a through 310e. In this example, thread 310c requires a new constant table. If thread 310e is the next thread that requires this new constant table as well, then the priority of thread 310e is elevated above threads that do not require the new constant table.

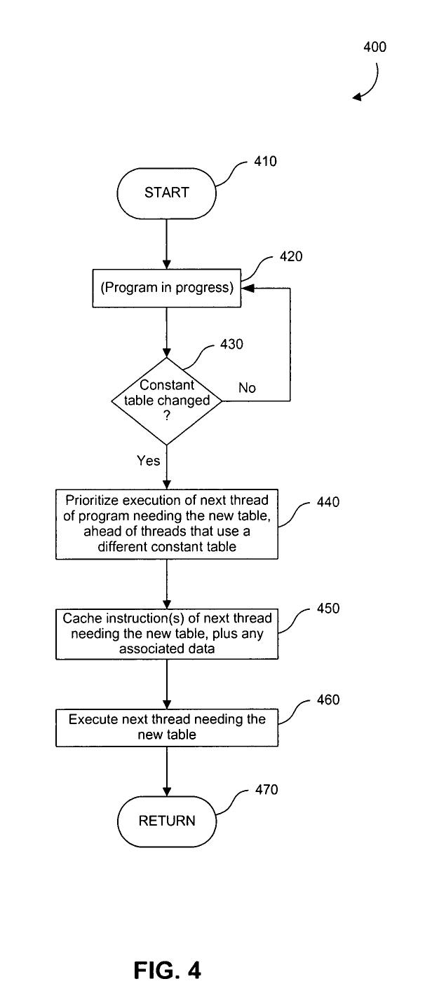

The process of this embodiment is illustrated in FIG. 4 as process 400. The process begins with step 410. In step 420, a program is in progress. In step 430, a determination is made as to whether the constant table has been changed. If so, then processing continues at step 440. Here, the execution of the next thread of the program needing the new table is prioritized ahead of threads that use a different constant table. As discussed above, this minimizes the instances at which the new constant table needs to be loaded or reloaded into working memory. In step 450, one or more instructions of the newly prioritized next thread to use that constant table are placed in an instruction cache. Any data associated with that instruction may also be placed in a cache. In step 460, this next thread is executed. The process concludes at step 470.

The invention can work with software, hardware, and/or operating system implementations other than those described herein. Any software, hardware, and operating system implementations suitable for performing the functions described herein can be used.

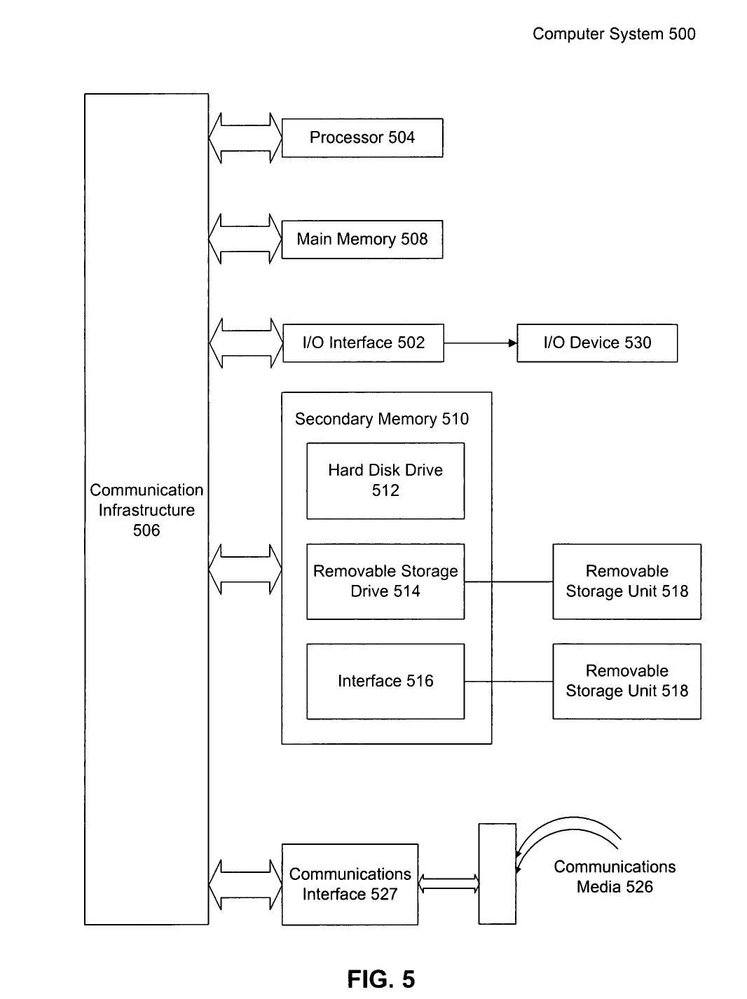

In an embodiment of the present invention, the system and components of the present invention described herein are implemented using well known computer systems, such as a computer system 500 shown in FIG. 5. The computer system 500 can be any commercially available and well known computer capable of performing the functions described herein, such as computers available from International Business Machines, Apple, Silicon Graphics Inc., Sun, HP, Dell, Compaq, Digital, Cray, etc. Alternatively, computer system 500 can be a custom built system.

The computer system 500 includes one or more processors (also called central processing units, or CPUs), such as a processor 504. This processor may be a graphics processor in an embodiment of the invention. The processor 504 is connected to a communication infrastructure or bus 506. The computer system 500 also includes a main or primary memory 508, such as random access memory (RAM). The primary memory 508 has stored therein control logic (computer software), and data.

The computer system 500 also includes one or more secondary memory storage devices 510. The secondary storage devices 510 include, for example, a hard disk drive 512 and/or a removable storage device or drive 514. The removable storage drive 514 represents a floppy disk drive, a magnetic tape drive, a compact disk drive, an optical storage device drive, tape drive, etc.

The removable storage drive 514 interacts with a removable storage unit 518. The removable storage unit 518 includes a computer useable or readable storage medium having stored therein computer software (control logic) and/or data. The logic of the invention as illustrated in FIGS. 2 and 4, for example, may be embodied as control logic. Removable storage unit 518 represents a floppy disk, magnetic tape, compact disk, DVD, optical storage disk, or any other computer data storage device. The removable storage drive 514 reads from and/or writes to the removable storage unit 518 in a well known manner.

The computer system 500 may also include input/output/display devices 530, such as monitors, keyboards, pointing devices, etc.

The computer system 500 further includes a communication or network interface 527. The network interface 527 enables the computer system 500 to communicate with remote devices. For example, the network interface 527 allows the computer system 500 to communicate over communication networks or mediums 526 (representing a form of a computer useable or readable medium), such as LANs, WANs, the Internet, etc. The network interface 527 may interface with remote sites or networks via wired or wireless connections.

Control logic may be transmitted to and from the computer system 500 via the communication medium 526. More particularly, the computer system 500 may receive and transmit carrier waves (electromagnetic signals) modulated with control logic via the communication medium 526.

Any apparatus or manufacture comprising a computer useable or readable medium having control logic (software) stored therein is referred to herein as a computer program product or program storage device. This includes, but is not limited to, the computer system 500, the main memory 508, the hard disk 512, and the removable storage unit 518. Carrier waves can also be modulated with control logic. Such computer program products, having control logic stored therein that, when executed by one or more data processing devices, cause such data processing devices to operate as described herein, represent embodiments of the invention.

It is to be appreciated that the Detailed Description section, and not the Abstract section, is intended to be used to interpret the claims. The Abstract section may set forth one or more but not all exemplary embodiments of the present invention as contemplated by the inventors, and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of sequencing, for execution, instructions of threads from a plurality of programs, the method comprising:
(a) while a first program is being executed, invoking a second program;
(b) prioritizing execution of instructions of a first thread of the second program, ahead of instructions of older threads of the first program; and
(c) caching an instruction of the first thread of the second program, plus any data associated with the instruction, resulting in a cache loaded with the instruction of the first thread of the second program.

2. The method of claim 1, further comprising:
(d) executing the instructions of the first thread of the second program, prior to executing the instructions of the older threads of the first program.

3. The method of claim 1, wherein said first and second programs execute on a graphics processor.

4. A method of sequencing, for execution, instructions of threads of a program, the method comprising:
(a) beginning execution of a program having a plurality of threads whose context comprises a table of constants;
(b) if the table changes during execution of the program, prioritizing execution of instructions of a next thread to use the changed table, ahead of instructions of threads using a different table of constants; and
(c) caching an instruction of the next thread, plus any data associated with the instruction, resulting in a cache loaded with the instruction of the next thread.

5. The method of claim 4, comprising:
(d) executing the cached instruction of the next thread, prior to executing the instructions of the threads using the different table of constants.

6. The method of claim 4, wherein said program executes on a graphics processor.

7. The method of claim 4, wherein said program comprises a shader program.

8. A computer program product comprising a computer usable medium having control logic stored therein for causing the sequencing, for execution, of instructions of threads from a plurality of programs, the control logic comprising:
(a) first computer readable program code means for causing the computer to prioritize execution of instructions of a first thread of a second program ahead of instructions of older threads of a first program, upon invocation of the second program; and
(b) second computer readable program code means for causing the computer to cache an instruction of the first thread of the second program, plus any data associated with the instruction, resulting in a cache loaded with the instruction of the first thread of the second program.

9. A computer program product comprising a computer usable medium having control logic stored therein for causing a computer to sequence, for execution, instructions of threads of a program, the control logic comprising:
(a) first computer readable program code means for causing the computer to prioritize execution of instructions of a next thread to use a changed table of constant, ahead of instructions of threads using a different table of constants;
(b) second computer readable program code means for causing the computer to cache an instruction of the next thread, plus any data associated with the next thread, resulting in a cache loaded with the instruction of the next thread.

10. A system for information processing, comprising:
(a) a processor; and
(b) a memory in communication with said processor, said memory for storing a plurality of processing instructions for directing said processor to:
(i) prioritize execution of instructions of a first thread of a second program, ahead of instructions of older threads of a first program, upon invocation of the second program; and
(ii) caching an instruction of the first thread of the second program, plus any data associated with the instruction, resulting in a cache loaded with the instruction of the first thread of the second program.

11. The system of claim 10, wherein said first and second programs are executable on said processor.

12. The system of claim 10 wherein said processor comprises a graphics processor.

13. A system for information processing, comprising:
(a) a processor; and
(b) a memory in communication with said processor, said memory for storing a plurality of processing instructions for directing said processor to:
(i) prioritize execution of instructions of a next thread to use a changed table of constants, ahead of instructions of threads using a different table of constants; and
(ii) cache an instruction of said next thread, plus any data associated with said next thread, resulting in a cache loaded with said instruction of said next thread.

14. The system of claim 13, wherein said threads execute on said processor.

15. The system of claim 13, wherein said processor comprises a graphics processor.

16. A method of sequencing program threads, comprising:
elevating the priority of instructions of a thread in the event of one of the following:
a) the thread is the first thread of a program that is invoked while an earlier program is executing, wherein instructions of the first thread are prioritized ahead of instructions of remaining threads of the earlier program; and
b) the thread is the next thread with instructions that require a constant table that was newly cached by an earlier thread whose instructions required the constant table.
